(19) United States
(12) Patent Application Publication
(10) Pub. No.: US 2009/0084041 A1
(43) Pub. Date: Apr. 2, 2009

(54) COEXTRUDED CORNER SEAL HAVING MATERIALS OF VARIED HARDNESS

(75) Inventors: Mark D. Foster, Pittsford, NY (US); Thomas M. Sesock, Pittsford, NY (US); Joseph J. Fragale, Webster, NY (US); Nino Milas, Penfield, NY (US)

Correspondence Address: Stephen B. Salai, Esq.;Harter Secrest & Emery LLP, 1600 Bausch & Lomb Place, Rochester, NY, 14604-2711, US

(73) Assignee: Schlegel Systems, Inc., Rochester, NY (US)

(21) Appl. No.: 11/865,598

(22) Filed: Oct. 1, 2007

(51) Int. Cl. E06B 7/16; B05D 3/12; B29C 47/00

(52) U.S. Cl. 49/479.1; 156/60; 264/176.1; 427/299

(57) ABSTRACT

A generally L-shaped corner seal includes an elongated leg comprising a material having a first hardness and an integral shorter leg comprising a material having a second hardness less than the first hardness.

### BACKGROUND OF THE INVENTION

1. Field of the Invention

The present invention relates to seals for sealing a door with respect to a jamb. More specifically, the present invention relates to a co-extruded, closed cell corner seal for use in sealing a door with respect to a door jamb.

2. Description of Related Art

Foam weather stripping is well known in the art as a way of preventing water and other unwanted contaminants from seeping past a closed door, window, or the like. More specifically, a weatherseal is generally applied to a door jamb or window frame for contacting by the respective door or window when such is closed. A typical weatherseal has a complex geometric shape and is typically manufactured in continuous or cut lengths to provide a seal between the door or window and associated jamb. Conventional weatherseals consist of foam-filled weather stripping, and are usually attached to a door or window frame by inserting a portion of the seal into a door or window kerf. Alternatively, the weatherseal may be attached to a doorjamb or window frame using adhesive tape or the like.

It has become evident to the inventors, however, that in many applications, a conventional weatherseal is not effective at completely prohibiting water and other elements from entering between the door or window and frame elements. For example, conventional weatherseals typically have an expanded open cell foam construction. The open cell construction, over time, allows water to seep through, and can thus compromise the integrity of the door.

A proposed method for reducing the amount of water that may seep past a conventional weatherseal is a corner seal. Corner seal pads have been used at the base and tops of door jambs to reduce or eliminate water infiltration past the interior jamb of the door. Conventional corner seal pads have a generally wedge-shaped cross-section and typically have an expanded open cell foam construction that is wrapped with an exterior PVC or Polypropylene liner. However, the inventors have found that the open cell foam construction of a conventional corner seal eventually allows water to soak into the corner seal pad and, over time, compromise the integrity of the door. For example, water may breach a typical open cell foam constructed corner seal pad by a method known as percolating. When a main doorjamb seal and a corner seal are not perfectly mated to each other, microscopic pin holes running perpendicular to each seal provide a means by which water can percolate between the mating seals, which can degrade the door over time.

Accordingly, there is a need in the art for an improved method of sealing a door with respect to a surrounding frame. Moreover, there is a need in the art for an improved corner seal that substantially prohibits a flow of water between a door or window and a frame. There also is a need in the art for a corner seal that effectively mates with a conventional weatherseal to cooperate therewith.

### SUMMARY OF THE INVENTION

The present invention remedies the foregoing needs in the art by providing a generally L-shaped corner seal for a hinged door. The generally L-shaped corner seal includes an elongated leg comprising a material having a first hardness and an integral shorter leg comprising a material having a second hardness less than the first hardness.

In another aspect of the invention, a seal for use between confronting members movable with respect to each other includes a first member and a second member. The first member includes a material having a first hardness. The second member is formed integrally with the first portion and includes a material having a second hardness.

In yet another aspect of the invention, a method of making a corner seal includes the steps of providing a first material having a first hardness, providing a second material having a second hardness, and coextruding the first material and the second material through a single die to form a unitary structure. Additionally steps form making the corner seal may include applying a slip coat to a portion of the corner seal, and applying an adhesive to a portion of the slip coat or the corner seal.

An understanding of these and other features of the present invention may be had with reference to the attached figures and following description, in which the present invention is illustrated and described.

### BRIEF DESCRIPTION OF THE SEVERAL VIEWS OF THE DRAWINGS

FIG. 1 is a top view of a preferred embodiment of the corner seal according to the present invention.

FIGS. 2a and 2b are top views of the preferred corner seal of FIG. 1 as used with a conventional door, FIG. 2a showing the door in an open position and FIG. 2b showing the door in a closed position.

### DETAILED DESCRIPTION OF THE PREFERRED EMBODIMENTS

Preferred embodiments of the present invention will be described with reference to the Figures.

The preferred embodiments will be described herein with reference to the preferred corner seal as used with a hinged door. However, the invention is not limited to use with a hinged door. It is contemplated that the corner seal according to the invention may be used with any confronting surfaces movable with respect to each other. For example, the corner seal may be used in conjunction with other hinged panel closures, e.g., windows or the like, as well as non-hinged, e.g., sliding, applications.

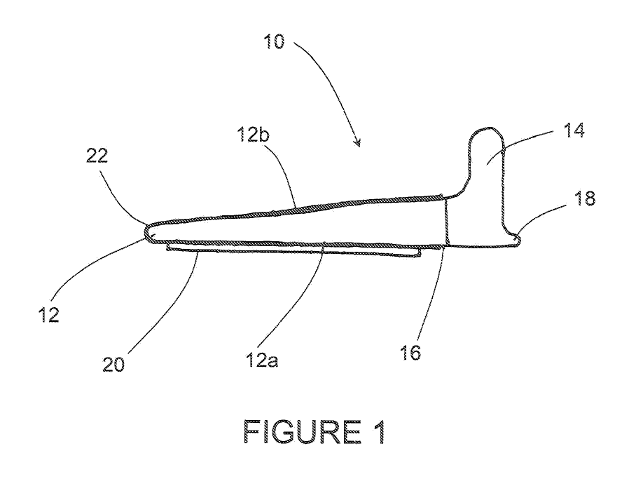

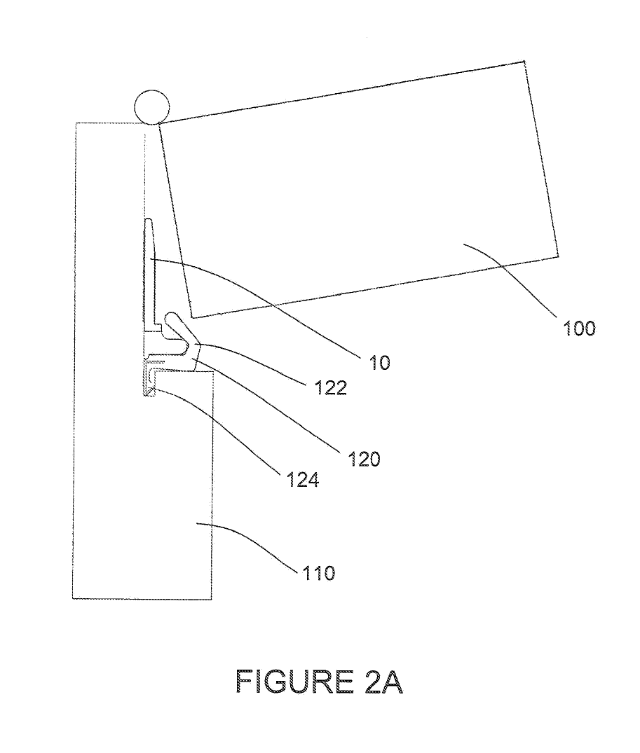

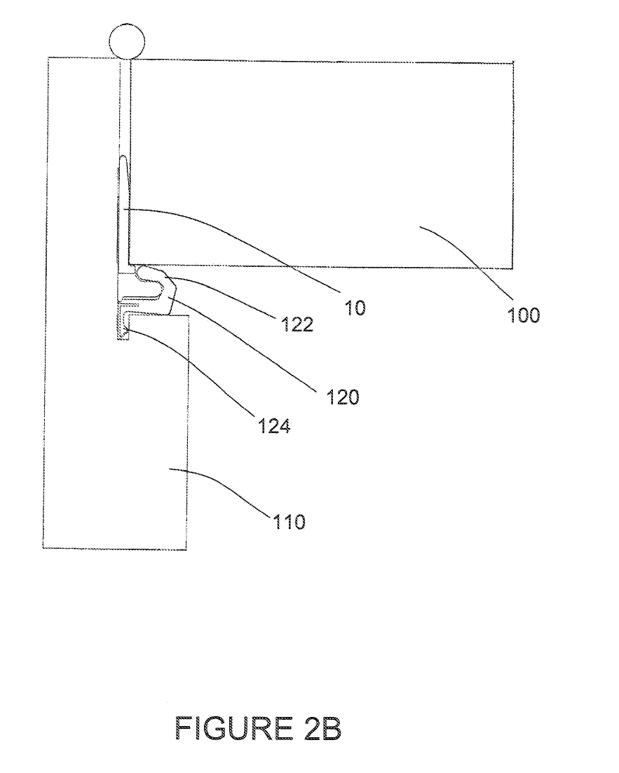

FIGS. 1 and 2 show a first preferred embodiment of the invention. As illustrated in FIG. 1, a preferred corner seal 10 according to the invention is generally L-shaped and includes a first, elongate leg 12 and, proximate an end thereof, an integrally formed second, shorter leg 14 substantially perpendicular to the first leg 12.

The elongate leg 12 preferably is tapered or wedged, such that the distal end of the member, i.e., opposite the second leg 14, is narrower than the end of the elongate leg 12 adjacent the second leg 14. As illustrated in FIG. 1, a back 16 of the corner seal 10 is substantially within a singe plane, for example, for abutment to a flat surface, such as a door jamb. Accordingly, a back 12a of the elongate leg 12 preferably is in the plane of the back 16 of the corner seal 10, and a front 12b of the elongate leg 12 is angled with respect to the back 12a of the elongate leg 12.

An adhesive 20 or similar attachment mechanism preferably is disposed on the back 12a of the elongate member 12, although the adhesive may be disposed anywhere along the back 16 of the corner seal 10. Preferably, a pressure sensitive adhesive is used that acts to adhere the corner seal to a doorjamb when applied. The adhesive preferably is semi-permanent, such that the corner seal will remain attached to the jamb upon application and during normal usage. It may be desirable that the corner seal be readily removable from a doorjamb, and thus the adhesive may be semi-permanent. Alternatively, no adhesive may be used and the corner seal may be applied using tape, nails, staples, or any other known attachment mechanisms. Those of ordinary skill in the art will readily understand that a number of methods may be used to affix a corner seal relative to a doorjamb. Such known methods are included within the scope of this description.

The corner seal 10 may further include a lip or protrusion 18 formed integrally therewith. As illustrated in the Figures, the lip 18 protrudes generally perpendicularly from the second, shorter leg 14 of the corner seal. A back of the lip preferably is coplanar with the back of the corner seal, so as to contact the door jamb when the corner seal is applied as described above. In use, the lip contacts a surface of the weatherseal to align the corner seal with respect to the weatherseal. The distance at which the lip protrudes from the shorter leg may vary depending upon the application, for example, depending upon the weatherseal being used. Preferably, however, the lip protrudes from the shorter leg from about 0.07 inches to about 0.12 inches, and more preferably from about 0.09 inches to about 0.10 inches.

Also in the preferred embodiment, a slip coat 22, as known in the art, preferably is applied to at least a portion of the corner seal. As illustrated in FIG. 1, a slip coat 22 made of, for example, a polymer such as, but not limited to, polyethylene or polypropylene, preferably is disposed over substantially all of the elongate leg 12. The slip coat 22 improves the impenetrability of the corner seal 10, and provides a surface to which the adhesive 20, described above, may be applied to the corner seal. Although the slip coat 22 is shown as applied only to the first member, the slip coat may be applied over the entirety of the corner seal, or over more or less of the corner seal than shown.

The preferred corner seal 10 preferably is made of closed cell foam, which is distinct from the open cell foam typically used in conventional weatherseal and corner seal applications. For example, a thermoplastic elastomer (TPE) is preferably used in the invention. It is also preferred that the corner seal 10 according to the preferred embodiment includes closed cell foam of varying hardnesses across the profile of the corner seal. In the preferred embodiment illustrated in FIG. 1, for example, the elongate leg 12 is made of a TPE having a first hardness, and the shorter, second leg 14 is made of TPE having a second hardness (as measured, for example, using a Shore durometer). In the preferred embodiment, the elongate leg 12 preferably is harder than the second, shorter leg 14. As illustrated in FIG. 1, a line A is used to illustrate the boundary between the material of the first hardness and the material of the second hardness.

Applicants have found this corner seal with multiple hardnesses provides an improved seal between a door panel and a jamb. Moreover, by using multiple materials with differing hardnesses, the inventors have found that the corner seal can more readily be adapted to different uses. Specifically, the inventors have found that using multiple hardnesses across the cross-section of the seal allows for manipulation of the point of flexion of the corner seal (i.e., the flexing of the seal that results from closing the door on the seal 10). In the preferred embodiment, a material is used for the elongate leg that is relatively harder than the material used for the shorter leg. This construction allows for sufficient rigidity of the elongate leg 12 when contacted by the door panel, and allows for added flexibility for the shorter leg 14, for example, to maintain sealing contact between the shorter leg 14 and the weatherseal. The inventors have found that hardnesses ranging from 5 durometer to 35 durometer are well suited for the invention. In particular, the relatively harder materials comprising the corner seal preferably are from about 20 to about 35 durometer, while the hardness of the relatively less hard material is preferably from about 5 to about 20 durometer.

Although the preferred embodiment utilizes two distinct areas of varied hardness, the invention also contemplates the use of more than two materials, each having a different hardness. Moreover, the same material may be used for more than one portion of the corner seal. For example, it may be desirable that the lip protruding from the second, shorter leg 14 be of a third hardness or of a material that is the same as the material used for the elongate leg 12. Any number of varied material combinations may be used to achieve an optimal corner seal for a given application.

FIGS. 2A and 2B illustrate the preferred corner seal 10 as used in conjunction with a door 100 hinged relative to a frame 110. The door assembly also includes a conventional weatherseal 20 comprising a generally V-shaped sealing portion 122 and a flange 124. As illustrated, the weatherseal 120 is attached to the frame 110 by inserting the flange 124 into an existing kerf. (The particular weatherseal 120 shown in FIG. 2 is used for illustrative purposes only. One of ordinary skill in the art will appreciate that a number of weatherseals are known and the corner seal of the present invention may be used with many different conventional weatherseals.) The corner seal is applied to the jamb by affixing the back 16 of the corner seal to the jamb 110 using the pre-applied adhesive or other affixing methods such as those described previously. The lip 16 preferably is abutted against a surface of the weatherseal, and the shorter leg 14 of the corner seal 10 is cooperatively received within the V-shaped portion of the conventional weatherseal 130. In this manner, the corner seal cooperates with the weatherseal to effectively seal the door and jamb.

The preferred corner seal as just described preferably is made using a co-extrusion process. Specifically, the corner seal is made by extruding the different materials of varied hardnesses comprising the seal simultaneously through a die or the like. Of course, the manufacturing of the corner seals is not limited to co-extrusion. For example, blow molding, injection molding, adding a blowing agent, and the like may also be used. Moreover, as described above, a slip coat may be applied to the corner seal using known means during or after the process of forming the corner seal. Preferably, the slip coat is applied using a co-extrusion method.

The corner seal according to the preferred embodiment may be of a length sufficient to extend along the entire vertical length of the door frame, i.e., from the floor to the top of the door frame, or of a shorter, pre-selected length for application, for example, proximate one or both of the top and bottom of the door. Of course, as the application requires, the corner seal may be used about more or less of the door frame.

The foregoing embodiments of the invention are representative embodiments, and are provided for illustrative purposes. The embodiments are not intended to limit the scope of the invention. Variations and modifications are apparent from a reading of the preceding description and are included within the scope of the invention. The invention is intended to be limited only by the scope of the accompanying claims.

1. A generally L-shaped corner seal for a hinged panel comprising:
an elongated leg comprising a material having a first hardness; and
an integral shorter leg comprising a material having a second hardness less than the first hardness.

2. The corner seal of claim 1 wherein the first leg comprises an adhesive layer.

3. The corner seal of claim 1 wherein the first leg comprises a tapered leg having a thicker portion abutting the second leg, and a thinner distal portion.

4. The corner seal of claim 1 wherein the first leg comprises foam.

5. The corner seal of claim 4 wherein the foam comprises closed cell foam.

6. The corner seal of claim 1 wherein the second leg comprises foam.

7. The corner seal of claim 6, wherein the second leg comprises closed cell foam.

8. The corner seal of claim 1 further comprising a lip projecting from the second leg at a substantially right angle.

9. The corner seal of claim 4, further comprising a fabric layer on the foam.

10. The corner seal of claim 6, further comprising a fabric layer on the foam.

11. The corner seal of claim 1, further comprising a continuous fabric layer covering the first and second legs.

12. The corner seal of claim 11, wherein the continuous fabric layer surrounds the first and second legs.

13. The corner seal of claim 1, wherein the first hardness is in a range of from about 5 durometer to about 20 durometer.

14. The corner seal of claim 1, wherein the second hardness is in a range of from about 20 durometer to about 35 durometer.

15. A seal for use between confronting members movable with respect to each other, the seal comprising:
a first portion comprising a material having a first hardness; and
a second portion formed integrally with the first portion and comprising a material having a second hardness.

16. The seal of claim 15 having a substantially L-shape, the first portion comprising a first leg and the second portion comprising a second leg substantially perpendicular to the first leg.

17. A method of manufacturing a corner seal, comprising
providing a first material having a first hardness;
providing a second material having a second hardness; and
coextruding the first material and the second material through a single die to form a unitary structure.

18. The method of claim 17 further comprising applying a slip coat over a portion of one or both of the first material and the second material.

19. The method of claim 18, further comprising applying a pressure sensitive adhesive on a portion of at least one of the first material, the second material, and the slip coat.
